(19) United States
(12) Patent Application Publication
(10) Pub. No.: US 2022/0164405 A1
(43) Pub. Date: May 26, 2022

(54) INTELLIGENT MACHINE LEARNING CONTENT SELECTION PLATFORM

(71) Applicant: SIGNAL FINANCIAL TECHNOLOGIES LLC, Wellesley, MA (US)

(72) Inventors: Konstantin Novakivsky, Boston, MA (US); John A. Calabrese, Wellesley, MA (US); Stephen H. Dow, Dover, MA (US); Nathan S. Cullivan, Plymouth, MA (US); Christopher J. Locke, Pittsford, NY (US); Evan S. Lavidor, Dracut, MA (US)

(21) Appl. No.: 17/522,447

(22) Filed: Nov. 9, 2021

Related U.S. Application Data
(60) Provisional application No. 63/116,410, filed on Nov. 20, 2020.

(51) Int. Cl. G06F 16/9536; G06F 11/34; G06N 20/00

(52) U.S. Cl. CPC G06F 16/9536; G06N 20/00; G06F 11/3495

(57) ABSTRACT

A machine learning model generates predicted performances of multiple entities at a future time based on corresponding ex post data associated with each of the multiple entities and corresponding entity profiles associated with each of the multiple entities. One or more items of content to be provided to one or more of the multiple entities are selected based on the predicted performances of the plurality of entities. An indication of the one or more items of content that are to be provided to the one or more of the multiple entities is transmitted to a third-party system.

### CROSS-REFERENCE TO RELATED APPLICATIONS

10011 This application claims the benefit of U.S. Provisional Patent Application No. 63/116,410, filed on Nov. 20, 2020, the disclosure of which is incorporated herein by reference in its entirety.

### TECHNICAL FIELD

Aspects of the present disclosure relate to a machine learning model, and more particularly, to an intelligent machine learning content selection platform.

### BACKGROUND

Machine learning models include computer algorithms that are improved and tuned through experience. A machine learning model is based on training data to produce a desired output without having programming that explicitly instructs the machine learning model to produce the desire output.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example computing architecture, in accordance with some embodiments.

FIG. 2 is a block diagram of an example workflow of an intelligent machine learning recommendation platform, in accordance with some embodiments of the disclosure.

FIG. 3 is a block diagram of an example intelligent machine learning recommendation platform, in accordance with embodiments of the disclosure.

FIG. 4 is a flow diagram of a method of a machine learning platform selecting recommended content based on predicted performance, in accordance with some embodiments.

FIG. 5A is an illustration of an example of a user interface presenting items of content to be provided to a particular entity, in accordance with embodiments of the disclosure.

FIG. 5B is an illustration of an example of a user interface presenting a set of entities to be provided a particular piece of content, in accordance with embodiments of the disclosure.

FIG. 6 is a block diagram of an example apparatus that may perform one or more of the operations described herein, in accordance with some embodiments of the present disclosure.

### DETAILED DESCRIPTION

An intelligent machine learning content selection platform is described. Advantageously, the combination of traditional and probabilistic approaches described herein produce a unique-to-each-entity projection and prediction model that consumes both discrete, observed quantitative data with continuous, non-observable, subjective, and intuitive inputs. The probabilistic service drives a series of “tuning” questions about an entity to a user and begins to self-learn based on the responses. The machine learning model also gives a means of observing and quantifying how trustworthy and accurate the user's predictions and certainty are—a critical insight for decision making—that are then incorporated into the unique-to-each-entity prediction model for ever-increasing accuracy and temporal range. In one embodiment of the system, these actions occur in a runtime environment enabling nearly-immediate computation with no offline processing, improving the performance of the platform.

The overall machine learning model may include multiple pieces. At a high level are the inputs of the ex post data associated with an entity that are used by the machine learning model. In embodiments, an entity may be an object, a user, a group of users, an organization, a system, a business, etc. that may be analyzed by the machine learning model. Ex post data may be data associated with the entity that is considered known data rather than a forecast. For example, if the entity was a business, then ex post data may include accounting data or other financial data, the business and credit profile, the inputs the user provides based on questions the platform asks, future scenarios the entity may experience, known events the entity will experience, subjective confidence over future events, and/or data on how the user interacts with the system. In some embodiments, supplemental data associated with the entity may be received from a third-party system. For example, supplemental data associated with an entity may be received from a vendor or other type of third-party.

The machine learning model may also incorporate rules logic. The rules logic may be used to calculate straightforward predictions for a particular entity. For example, if the entity is a business, then the rules logic may include the past data, the past financial performance metrics, and the initial forecast of trends. The platform may then apply additional logic on top of the rules logic for a more precise forecast. This may include the stochastic simulation for uncertainty using only past data, as well as the probabilistic modeling which incorporates a user's heuristics, predictions, and certainty of future events.

The machine learning model may utilize these predicted performances to intelligently select content that is to be provided to an entity by a third-party system. For example, the machine learning model may select content that is related to a predicted future event associated with the entity. In another example, the machine learning model may select content that is relevant to an increase or decrease in predicted performance of the entity. Upon selecting the content based on the predicted performance, an indication of the content selection may be transmitted to a third-party system. In some embodiments, the indication may be provided via a user interface to the third-party system. The third-party system may then determine whether to send the selected content to the entity.

In embodiments, the machine learning model may be trained by utilizing a set of training data that the machine learning model learns from. In some embodiments the set of training data may include one or more sets of ex post data that is associated with the entity and considered known data rather than forecast data. During the training process, the set of training data may be provided as an input to the machine learning model to cause the machine learning model to produce an output (e.g., the predicted performances). The output for the set of training data may be compared to an expected output of the machine learning model to determine whether the machine learning model has produced the correct output.

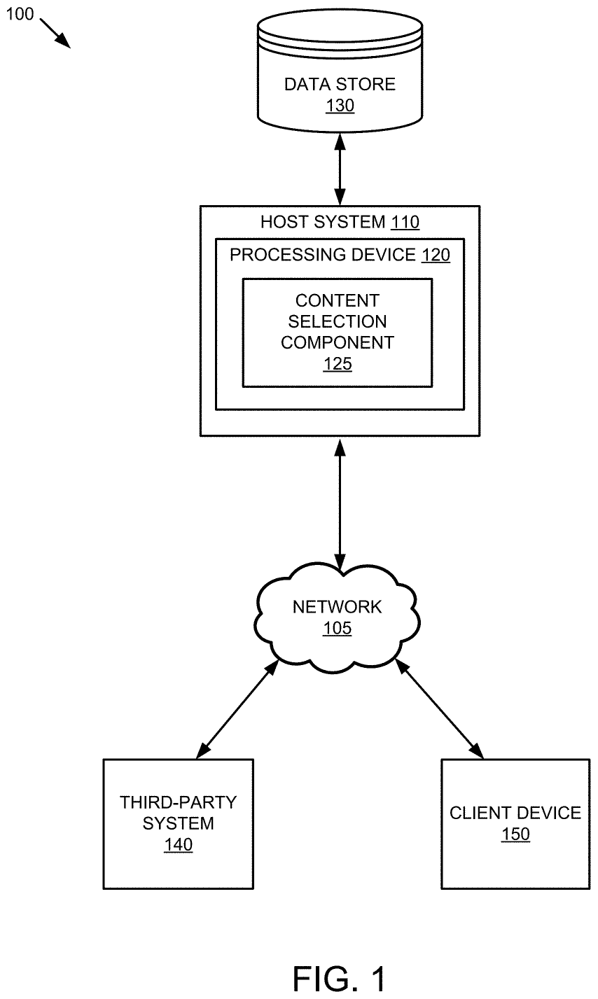

FIG. 1 is a block diagram that illustrates an example computing architecture 100, in accordance with some embodiments of the present disclosure. The computing architecture 100 may include host system 110, third-party system 140, and client device 150.

As illustrated in FIG. 1, computing architecture 100 includes host system 110 that includes computing processing device 120 and data store 130. The host system 110, third-party system 140, and client device 150 are coupled to each other (e.g., may be operatively coupled, communicatively coupled, may communicate data/messages with each other) via network 105. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a WiFi′ hotspot connected with the network 105 and/or a wireless carrier system that can be implemented using various data processing equipment, communication towers (e.g. cell towers), etc. The network 105 may carry communications (e.g., data, message, packets, frames, etc.) between the various components of host system 110.

The data store 130 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

Each component may include hardware such as processing devices (e.g., processors, central processing units (CPUs), memory (e.g., random access memory (RAM), storage devices (e.g., hard-disk drive (HDD), solid-state drive (SSD), etc.), and other hardware devices (e.g., sound card, video card, etc.). The host system 110, third-party system 140, and client device 150 may include any suitable type of computing device or machine that has a programmable processor including, for example, server computers, desktop computers, laptop computers, tablet computers, smartphones, set-top boxes, etc. In some examples, host system 110, third-party system 140, and client device 150 may comprise a single machine or may include multiple interconnected machines (e.g., multiple servers configured in a cluster). In embodiments, host system 110 may be part of a cloud computing system. Host system 110, third-party system 140, and client device 150 may execute or include an operating system (OS), as discussed in more detail below. The OS of a server may manage the execution of other components (e.g., software, applications, etc.) and/or may manage access to the hardware (e.g., processors, memory, storage devices etc.) of the computing device.

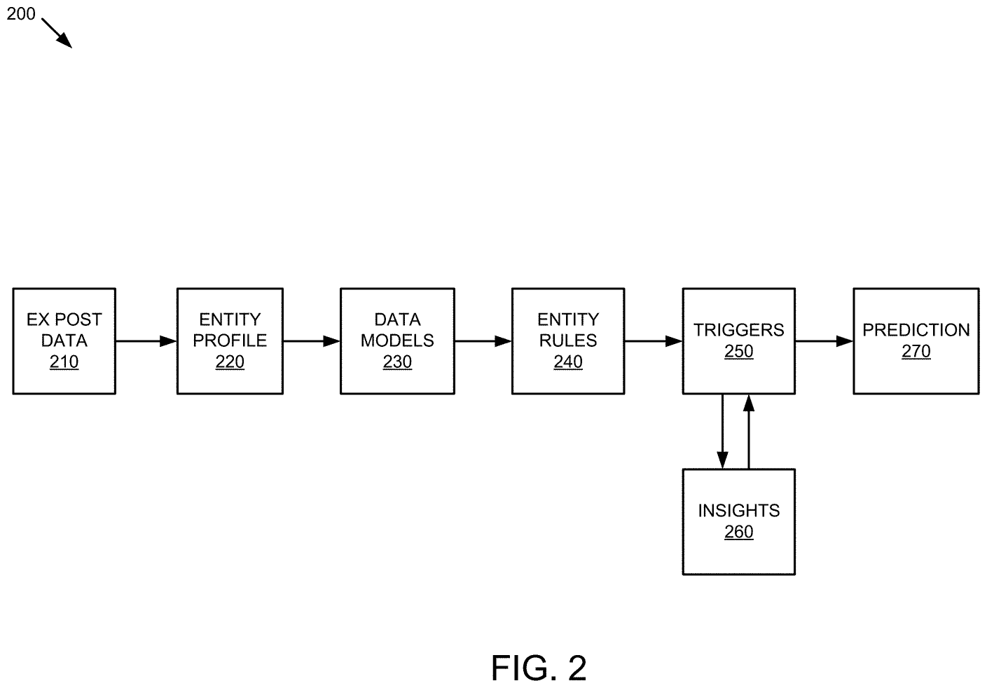

In embodiments, processing device 120 may execute a content selection component 125. In embodiments, the content selection component 125 may include at least part of a machine learning model for intelligently selecting content based on predicted performances of entities. The content selection component 125 may receive ex post data associated with an entity. The content selection component 125 may further receive an entity profile associated with the entity. The content selection component 125 may generate a predicted performance of the entity at a future time based on the ex post data and the entity profile. The content selection component 125 may receive requests for content recommendations from third-party system 140. The content selection component 125 may further transmit an indication of recommendations of content from third-party system 140 Further details regarding the content selection component 125 are discussed at FIGS. 2-5B below.

In embodiments, the data store 130 may include a repository of one or more pieces of content that may be provided to entities selected by the content selection component 125. In some embodiments, the content may include messages that may be provided to the entities. In embodiments, the content may include videos, pictures, music, websites, articles, etc. that may be provided to the entities. In an embodiment, the content may include offers or advertisements that may be provided to the entities. In embodiments, the content may include templates for communications that may be personalized to include information associated with the entities.

FIG. 2 is a block diagram 200 of an example workflow of an intelligent machine learning recommendation platform, in accordance with some embodiments of the disclosure. The workflow may begin when a machine learning platform receives ex post data 210 associated with an entity. Ex post data 210 may be data associated with the entity that is considered known data rather than a forecast. In embodiments, the ex post data 210 may include one or more performance statistics that are indicative of the historical performance of the entity. For example, if the entity was a business, then ex post data may include accounting data or other financial data, the business and credit profile, the inputs the user provides based on questions the platform asks, future scenarios the entity may experience, known events the entity will experience, subjective confidence over future events, and/or data on how the user interacts with the system.

In some embodiments, the machine learning platform may establish one or more interfaces with applications or other external data sources associated with the entity for the receipt of the ex post data 210. For example, if the entity is a business, the machine learning platform may establish interfaces with accounting applications, bank accounts, payroll applications, performance benchmarking, etc. to receive the ex post data 210 without requiring the ex post data 210 to be provided by a user associated with the entity.

The machine learning platform may receive an entity profile 220 for the entity. The entity profile 220 may include one or more characteristics that are associated with or describe the entity that a prediction is being generated for. For example, if the entity is a business, then the entity profile 220 may include characteristics such as the type of business, the location of the business, etc.

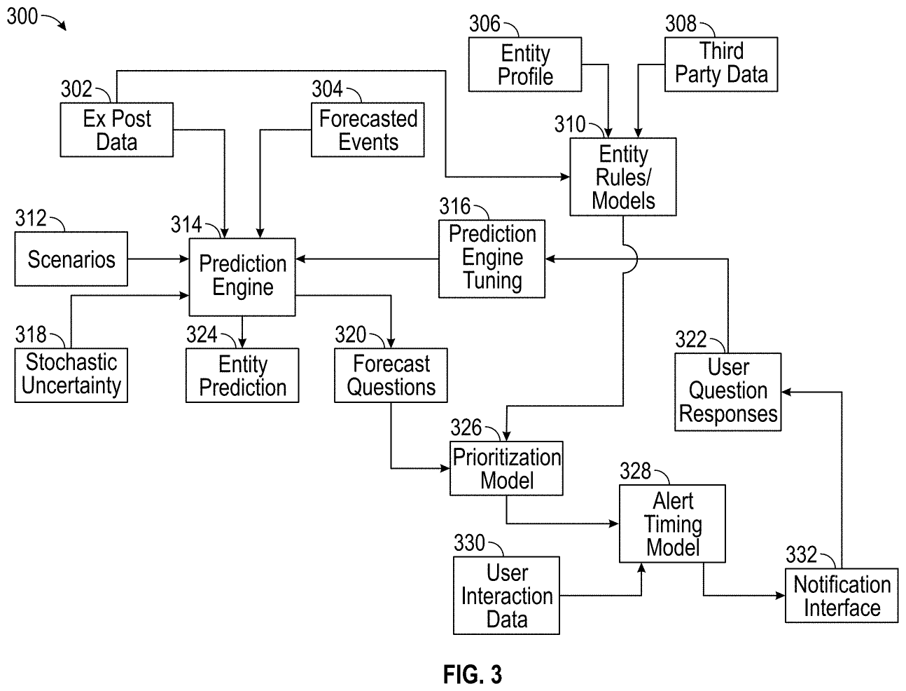

The machine learning platform may utilize one or more data models 230 that may be used by the machine learning model to analyze the ex post data 210 and any subsequently received data associated with the entity. In some embodiments, the types of data models 230 that may be used may be determined based on information included in the entity profile 220. For example, certain data models 230 may be used for a particular type of entity, while other data models 230 may be used for a different type of entity. Further details regarding various types of data models 230 that may be implemented by the machine learning platform are described at FIG. 3 below.

The machine learning platform may utilize one or more entity rules 240 that are associated with the entity. In embodiment, the entity rules 240 may be one or more rules that are followed by the machine learning model to analyze data or generate alerts or questions that are to be provided to the user based on the ex post data 210 and/or the entity profile 220.

In embodiments, the entity rules 240 may include statistical calculation rules. The statistical calculation rules may include rules logic that analyzes the ex post data 210 and generates a user interface that presents some high-level relevant information to a user associated with the entity based on the analysis. For example, if the entity is a business, the rules logic may calculate monthly values for total revenue, total expenses, month end invoices, month end bills, gross margin, and net margin and generate a user interface to present these values to the user.

In embodiments, the entity rules 240 may include a data insights rules model that generates insights associated with the entity in the form of alerts that are provided to a client device (e.g., client device 150 of FIG. 1) of a user associated with the entity and/or a third-party system (e.g., third-party system 140 of FIG. 1). The alerts may be presented to the user via a user interface at the client device. In embodiments, an alert may include a remedial action insight that recommends an action to be performed by the user. For example, if the entity is a business, then a remedial action insight may be a recommendation for the user to contact any customers that are late on their payments. In an embodiment, the alert may include an insight that a performance statistic associated with the entity is predicted to fall below a threshold value. For example, if the entity is a business, the alert may indicate that the cash flow of the business is predicted to fall below a threshold value. In some embodiments, an alert may include comparisons with other entities of a similar type to benchmark the entity's performance relative to similar entities. For example, the ex post data 210 of the entity may be compared to third-party data indicating the performance statistics of other similar entities and used to generate an alert for the user to benchmark the performance of the entity.

In some embodiments, the entity rules 240 may include a question triggers rules model that generates one or more questions that are to be transmitted to a client device of a user associated with the entity. The questions may be presented to the user via a user interface displayed by the client device. In embodiments, the questions may be generated based on anomalies that are identified by the machine learning model in the ex post data 210 when comparing a predicted value with an actual value, or when more information is needed to provide a more accurate prediction. For example, if the entity is a business and the machine learning model notices a large increase in sales in the month of October, the question may ask the user if this increase in sales is likely to occur again, or if this was an isolated event. Other examples of questions may include questions on periodicity, questions on growth trends, or questions based on a predicted value not matching up with an actual value.

The machine learning model may analyze the ex post data 210 in view of the entity profile 220, data models 230, and entity rules 240 to determine whether any triggers 250 have been activated that would cause the transmission of an alert or question to the user associated with the entity. In embodiments, a trigger 250 may correspond to an anomaly in the ex post data 210, insufficient data being present in the ex post data 210 to make an accurate prediction, or the like.

Upon determining that a trigger 250 has been activated, the machine learning platform may query the available insights 260 for the entity to determine one or more insights that are relevant to the event that activated the trigger 250. In embodiments, the insights 260 may include the information provided by the data models 230 and entity rules 240 described above. For example, if the event that activated the trigger was an anomaly in the ex post data 210, then the insights 260 may indicate that a question should be transmitted to the user prompting the user to clarify the anomaly.

In embodiments, upon resolution of the triggers 250, the machine learning model may generate a prediction 270 for the entity. The prediction 270 for the entity may correspond to a predicted performance of the entity at a future time. In some embodiments, the predicted performance may correspond to a predicted value of one or more performance statistics associated with the entity at a future time. For example, if the entity is a business, then the predicted performance may include predictions for performance statistics associated with the business, such as cash flow, cash on hand, debt, payroll, etc., at a future time.

FIG. 3 is a block diagram of an example intelligent machine learning recommendation platform 300, in accordance with embodiments of the disclosure. In embodiments, at least a portion of the intelligent machine learning recommendation platform 300 may be implemented by content selection component 125 of FIG. 1.

The intelligent machine learning recommendation platform 300 (also referred to as “platform” hereafter) may include ex post data 302 associated with an entity, an entity profile 306, and relevant third party data 308, as previously described. The ex post data 302, entity profile 306, and third party data 308 may be provided to entity rules/models 310, such as the data models 230 and entity rules 240 of FIG. 2, for monitoring and analysis.

The platform may include a prediction engine 314 that implements a machine learning model that generates performance predictions (e.g., entity prediction 324) for the entity based on various inputs associated with the entity. Inputs that may be provided to the prediction engine 314 may include ex post data 302, forecasted events 304, scenarios 312, and stochastic uncertainty 318.

Forecasted events 304 may correspond to potential events that are relevant to the entity that may occur at a future time. In some embodiments, a known forecast model may be used to identify forecasted events 304. The known forecast model may identify known events that will occur in the future based on the ex post data 210, entity profile 306, third party data 308, etc. For example, if the entity is a business, the known forecast model may identify a known forecast event as a loan payment being due on a particular date. In embodiments, the known forecast model may project revenue and expense data points (e.g., accounts receivable (AR) and accounts payable (AP)) for the business of which the platform is aware into the future, and to use past AR and AP items to predict how future AR and AP will look. The known forecast model may also look at the current invoices and bills, and project them forward and may use an anticipated payment date and amount based on past behavior for that entity.

In embodiments, a trends forecast model may be used to identify forecasted events 304. The trends forecast model may analyze past data, such as ex post data 302, and predict forecasted events based on trends identified in the data. In embodiments, the trends forecast model may do this by identifying a periodicity for a particular event in the past data. For example, the trends forecast model may identify that a particular event occurs approximately once a month. The trends forecast model may then determine the impact on performance statistics of the entity that the forecasted event will have based on the future performance. In embodiments, the trends forecast model may also calculate standard deviations in the past data to generate uncertainty for the forecasted event.

Scenarios 312 may correspond to the user's heuristics, judgments, plans, and predictions that are unstructured and not extractable from existing data sources but are a critical input to the machine learning model and will generate scenarios reflecting the various options for a decision with future implications. These inputs may be prompted by the probabilistic model suggesting various scenarios in the form of forecast questions 320, as described below, or by the user independently creating a new scenario or event.

A further input for the machine learning model may be stochastic uncertainty 318. This may include a stochastic simulation for uncertainty using the ex post data 302. In embodiments, stochastic simulation may be applied to the forecast events 304 to generate values for stochastic uncertainty 318. The stochastic uncertainty 318 may be applied to the forecast events 304 to generate uncertainty by applying the knowns, the trends, and potentially the events if the events are not provided to a probabilistic model. In embodiments, a Monte Carlo simulation or other similar type of simulation may be used.

Using these inputs, the prediction engine 314 may generate a first entity prediction 324. As previously discussed, the entity prediction may correspond to a predicted performance of the entity at a future time. The predicted performance may correspond to one or more performance statistics associated with the entity. In some embodiments, the platform may generate a user interface for presenting the entity prediction 324 to a user associated with the entity. For example, the platform may generate a user interface including one or more charts, graphs, tables, spreadsheets, etc. that present the user with the information associated with the entity prediction 324. The platform may transmit the user interface including the information associated with the entity prediction 324 to a client device (e.g., client device 150 of FIG. 1) associated with the user, where in the user interface is subsequently displayed by the client device.

In embodiments, the platform may transmit one or more forecast questions 320 to the client device of the user to prompt the user's input. In embodiments, the forecast questions 320 may be determined using the based on one or more entity rules, such as entity rules 240 of FIG. 2. In embodiments, the questions may be transmitted as a notification to the client device and include a user interface that enables a user to provide their responses to the questions. The user's responses may indicate whether a forecasted event is going to occur and assign a certainty value to how certain the user is that the event is going (or not going to) occur. For example, a user may provide an input to the client device via the user interface indicating that the user believes the forecasted event is going to occur with 80% certainty.

In embodiments, the platform may utilize a prioritization model 326, which may come in two or more forms. The prioritization model 326 may begin as a rules based model, and then evolve into a probabilistic model. A goal of this model may be to generate a prioritized listing of insights/questions based on the generated relevant insights and questions using the data insights rules and question triggers rules, respectively. The prioritization model 326 may also use information found in the entity profile 306, such as the entity type, location, etc., to prioritize which insights/questions are displayed in which order in the listing.

In embodiments, the platform may utilize an alert timing model 328 which may come in two forms. The alert timing model 328 may begin as a rules based model, and then evolve into a probabilistic model. A goal of the alert timing model may be to determine the contact frequency, timing, and mode with which to alert the user based on user interaction data 330. The user interaction data 330 may include information associated with how and when the user interacts with data provided to the user by the platform. In embodiments, the user interaction data 330 may include in-app behavior, a user profile, or question and insight lists from the data insights rules and question triggers rules. For example, the user interaction data may indicate what times of day a user typically access data, notifications, alerts, etc. provided by the system, which types of notifications/alerts the user views, and which types of notifications/alerts the user ignores. It is possible that varying alert settings per user depending on the type of alert may be implemented, or it is also possible that one setting per user for all possible alerts may be implemented. Additionally, the priority of the alerts from the prioritization model 326 may be included.

The notification interface 332 may generate one or more notifications to be transmitted by the platform. In embodiments, the notifications may be transmitted to a client device of a user associated with the entity. In embodiments, the notifications may be transmitted to a third-party system (e.g., third-party system 140). For example, if the entity is a business, then the notifications may be transmitted to a bank or lender of the business. In some embodiments, the notifications may be generated and transmitted based on the determinations of the forecast questions 320, the prioritization model 326, and/or the alert timing model 328. For example, the notifications may be transmitted to the client device at a particular time, in a particular order, and in a particular format based on the prioritization model 326 and alert timing model 328. In embodiments, the notifications may include entity prediction 324, as previously described. The notification may be transmitted in various forms, such as through email, text messaging, push notifications, in-application communications, etc.

After transmitting the notifications, the platform may receive user question responses 322 that correspond to a user's responses to the forecast questions 320 and any other questions that may be presented to the user. The user's responses may be used to perform prediction engine tuning 316. The prediction engine tuning 316 may adjust the entity prediction 324 generated by the prediction engine 314 based on the user question responses 322. The prediction engine tuning 316 may be a model that takes inputs from user-identified events, user-identified scenarios, and use question responses 322 to adjust the uncertainty. Each of these user inputs comes with a certainty meter which is incorporated into the model, along with values of the forecasted value and actual value (for questions), and user-provided estimates. The data for this model may include user inputs and data calculated in the trends forecast rules model (e.g., predicting trends) and in the knowns forecast rules model (e.g., predicting specific financial metrics). The forecasted data is compared with actual data and with user inputs. In an embodiment, the user is provided a means of inputting multiple scenarios about future events and applying those in a runtime system to see the impact on the future state under various conditions of certainty. These simulations may then be selected as a baseline for future predictions of other events, or removed as the case may be. Over time the machine self-learns and tunes the predictions with more accuracy. Upon performing the prediction engine tuning 316, the prediction engine 314 may generate a subsequent entity prediction 324.

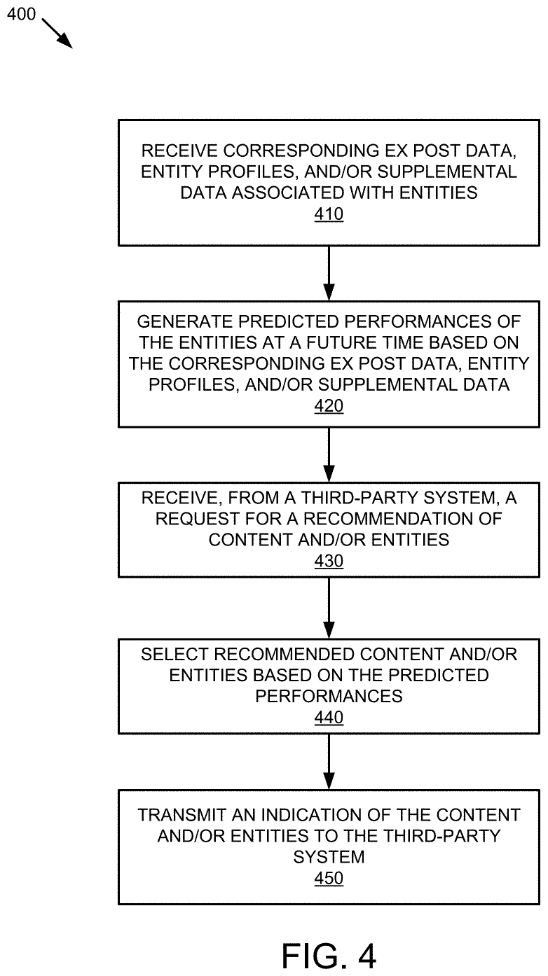

FIG. 4 is a flow diagram of a method 400 of a machine learning platform selecting recommended content based on predicted performance, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by content selection component 125 of FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic executing a machine learning model receives corresponding ex post data and entity profiles associated with multiple entities. In some embodiments, the processing logic may receive supplemental data from a third-party system (e.g., third-party system 140 of FIG. 1).

At block 420, the processing logic generates predicted performances for the multiple entities at a future time based on the corresponding ex post data and the entity profiles. In some embodiments, the processing logic may further use the supplemental data received from the third-party system to generate the predicted performances.

At block 430, the processing logic receives, from the third-party system, a request for a recommendation of content and/or entities. In some embodiments, the request may be for recommendations of one or more items of content that are to be provided to a particular entity. For example, a third-party system may identify a particular entity that the third-party system wishes to provide content to and may request recommended content for that particular user. In embodiments, the request may be for recommendations of one or more entities that a particular piece of content is to be provided to. For example, the third-party system may have a particular piece of content they would like to distribute to entities and may request a recommendation for a set of entities that the particular piece of content is to be provided to.

At block 440, the processing logic selects recommended content and/or entities based on the predicted performances. In some embodiments, the processing logic may select the content and/or entities based on the request received at block 430. For example, if the request was for one or more content items that are to be provided to a particular entity, then the processing logic may select one or more items of content based on the predicted performance of the particular entity. In another example, if the request was for a set of entities that a particular piece of content is to be provided to, then the processing logic may select a set of entities that the piece of content is to be provided to based on the corresponding predicted performances of each of the set of entities.

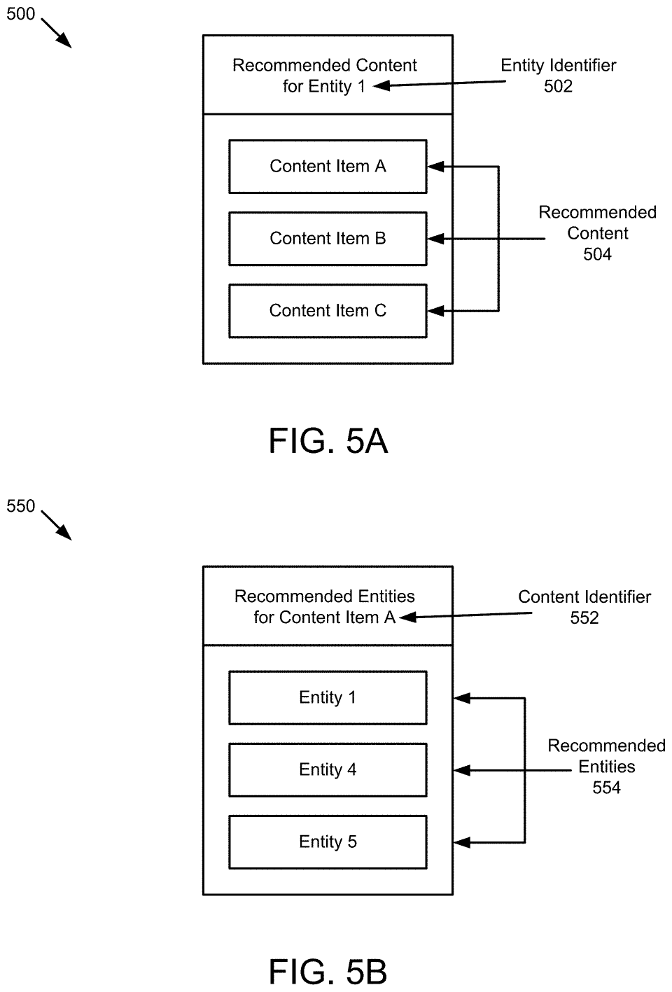

At block 450, the processing logic transmits an indication of the content and/or entities to the third-party system. In some embodiments, the processing logic may generate a user interface for presenting the indication of the content and/or entities at the third-party system, as will be described in further detail and FIG. 5A and FIG. 5B below.

FIG. 5A is an illustration of an example of a user interface 500 presenting items of content to be provided to a particular entity, in accordance with embodiments of the disclosure. As previously described, in some embodiments content selection component 125 of FIG. 1 may generate a user interface for presenting the indications of recommended content that is to be provided to an entity. In some embodiments, the user interface 500 may be provided to a third-party system (e.g., third-party system 140 of FIG. 1) requesting content recommendations.

Referring to FIG. 5A, user interface 500 may be generated in response to receiving a request for one or more pieces of content that are to be provided to a particular entity (e.g., Entity 1). Upon receiving the request, the content selection component 125 may select Content Item A, Content Item B, and Content Item C that are to be provided to Entity 1 based on a predicted performance of Entity 1, as previously described. The content selection component 125 may generate user interface 500 that includes an entity identifier 502 and recommended content 504. The entity identifier 502 may indicate which entity (e.g., Entity 1) the content items are to be provided to.

The recommended content 504 may present the indications of the pieces of content to be provided to the entity that were selected by the content selection component 125. In some embodiments, each piece of recommended content 504 may include a corresponding selectable icon that may cause the performance of one or more actions associated with a piece of recommended content when selected by the third-party system. For example, selection of a selectable icon for Content Item B may cause the performance of one or more actions associated with Content Item B. In some embodiments, the action may include providing additional information associated with the content item. In embodiments, the action may include providing the content item to the entity. In embodiments, the action may include providing additional information associated with the entity, such as displaying information from the entity profile of the entity. In some embodiments, other actions may be performed in response to a selection of the selectable icon.

FIG. 5B is an illustration of an example of a user interface 550 presenting a set of entities to be provided a particular piece of content, in accordance with embodiments of the disclosure. In some embodiments, the user interface 550 may be provided to a third-party system (e.g., third-party system 140 of FIG. 1) requesting content recommendations.

Referring to FIG. 5B, user interface 550 may be generated in response to receiving a request for a set of entities that are to be provided to a particular piece of content (e.g., Content Item A). Upon receiving the request, the content selection component 125 may select Entity 1, Entity 4, and Entity 5 that are to be provided Content Item A based on the predicted performances of Entity 1, Entity 4, and Entity 5, as previously described. The content selection component 125 may generate user interface 550 that includes a content identifier 552 and recommended entities 554. The content identifier 552 may indicate the content item (e.g., Content Item A) that is to be provided to the recommended entities 554.

The recommended entities 554 may present the indications of the entities that were selected by the content selection component 125. In some embodiments, each entity of the recommended entities 554 may include a corresponding selectable icon that may cause the performance of one or more actions associated with the recommended entity when selected by the third-party system. For example, selection of a selectable icon for Entity 1 may cause the performance of one or more actions associated with Entity 1. In some embodiments, the action may include providing additional information associated with the entity. In embodiments, the action may include providing the content item to the entity. In some embodiments, other actions may be performed in response to a selection of the selectable icon.

It should be noted that the user interface 500 of FIG. 5A and user interface 550 of FIG. 5B are shown for illustrative purposes only and are not intended to limit the scope of the disclosure. Embodiments of the disclosure may include generating user interfaces having various configurations, different information, different appearances, or the like.

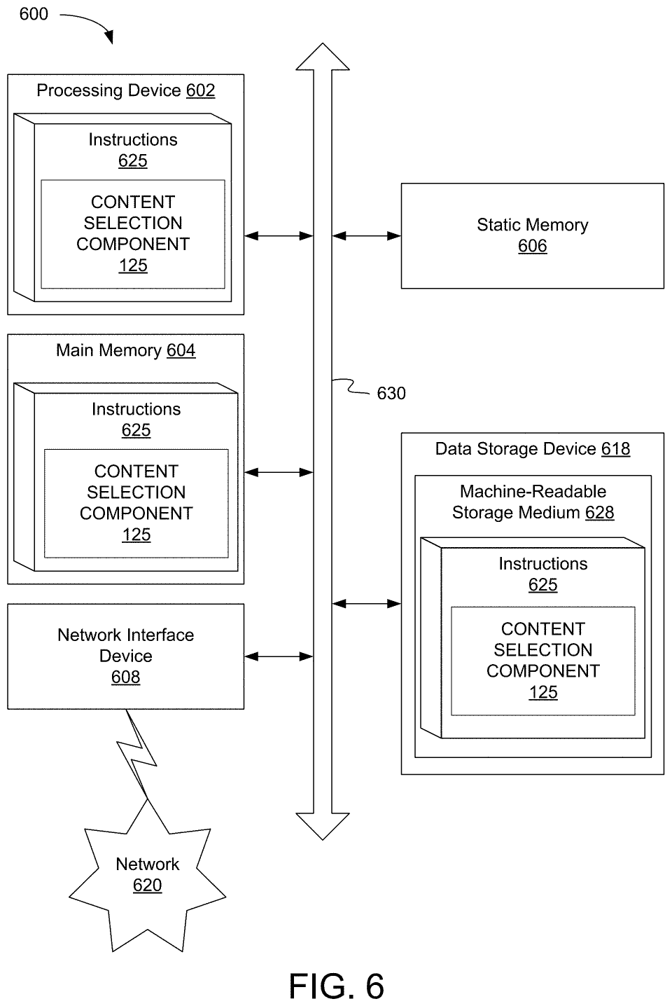

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a content selection component, e.g., content selection component 125 for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “generating,” “selecting,” “transmitting,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
generating, by a processing device executing a machine learning model, predicted performances of a plurality of entities at a future time based on corresponding ex post data associated with each of the plurality of entities and corresponding entity profiles associated with each of the plurality of entities;
selecting one or more items of content to be provided to one or more of the plurality of entities based on the predicted performances of the plurality of entities; and
transmitting, to a third-party system, an indication of the one or more items of content that are to be provided to the one or more of the plurality of entities.

2. The method of claim 1, further comprising:
receiving, from the third-party system, a request for a recommendation for content for a particular entity of the plurality of entities, wherein the one or more items of content are selected based on a predicted performance of the particular entity.

3. The method of claim 1, further comprising:
receiving, from the third-party system, a request for a recommendation of a set of entities of the plurality of entities that a particular piece of content is to be provided to, wherein the recommendation is determined based on the predicted performances of the set of entities; and
transmitting, to the third-party system, the set of entities that the particular piece of content is to be provided to.

4. The method of claim 1, further comprising:
receiving, from the third-party system, supplemental data associated with the plurality of entities, wherein the predicted performances of the plurality of entities are generated based on the supplemental data.

5. The method of claim 1, further comprising:
generating a user interface for presenting the indication of the one or more items of content that are to be provided to the one or more of the plurality of entities; and
providing the user interface comprising the indication to the third-party system.

6. The method of claim 1, wherein the corresponding ex post data comprises corresponding performance statistics for each of the plurality of entities.

7. The method of claim 1, wherein the corresponding entity profiles comprise corresponding properties associated with each of the plurality of entities.

8. An apparatus comprising:
a memory; and
a processing device, operatively coupled to the memory, to:
generate, by a machine learning model, predicted performances of a plurality of entities at a future time based on corresponding ex post data associated with each of the plurality of entities and corresponding entity profiles associated with each of the plurality of entities;
select one or more items of content to be provided to one or more of the plurality of entities based on the predicted performances of the plurality of entities; and
transmit, to a third-party system, an indication of the one or more items of content that are to be provided to the one or more of the plurality of entities.

9. The apparatus of claim 8, wherein the processing device is further to:
receive, from the third-party system, a request for a recommendation for content for a particular entity of the plurality of entities, wherein the one or more items of content are selected based on a predicted performance of the particular entity.

10. The apparatus of claim 8, wherein the processing device is further to:
receive, from the third-party system, a request for a recommendation of a set of entities of the plurality of entities that a particular piece of content is to be provided to, wherein the recommendation is determined based on the predicted performances of the set of entities; and
transmit, to the third-party system, the set of entities that the particular piece of content is to be provided to.

11. The apparatus of claim 8, wherein the processing device is further to:
receive, from the third-party system, supplemental data associated with the plurality of entities, wherein the predicted performances of the plurality of entities are generated based on the supplemental data.

12. The apparatus of claim 8, wherein the processing device is further to:
generate a user interface for presenting the indication of the one or more items of content that are to be provided to the one or more of the plurality of entities; and
provide the user interface comprising the indication to the third-party system.

13. The apparatus of claim 8, wherein the corresponding ex post data comprises corresponding performance statistics for each of the plurality of entities.

14. The apparatus of claim 8, wherein the corresponding entity profiles comprise corresponding properties associated with each of the plurality of entities.

15. A non-transitory computer-readable storage medium including instructions that, when executed by a processing device of a first host system, cause the processing device to:
generate, by the processing device executing a machine learning model, predicted performances of a plurality of entities at a future time based on corresponding ex post data associated with each of the plurality of entities and corresponding entity profiles associated with each of the plurality of entities;
select one or more items of content to be provided to one or more of the plurality of entities based on the predicted performances of the plurality of entities; and
transmit, to a third-party system, an indication of the one or more items of content that are to be provided to the one or more of the plurality of entities.

16. The non-transitory computer-readable storage medium of claim 15, wherein the processing device is further to:
receive, from the third-party system, a request for a recommendation for content for a particular entity of the plurality of entities, wherein the one or more items of content are selected based on a predicted performance of the particular entity.

17. The non-transitory computer-readable storage medium of claim 15, wherein the processing device is further to:
receive, from the third-party system, a request for a recommendation of a set of entities of the plurality of entities that a particular piece of content is to be provided to, wherein the recommendation is determined based on the predicted performances of the set of entities; and
transmit, to the third-party system, the set of entities that the particular piece of content is to be provided to.

18. The non-transitory computer-readable storage medium of claim 15, wherein the processing device is further to:
receive, from the third-party system, supplemental data associated with the plurality of entities, wherein the predicted performances of the plurality of entities are generated based on the supplemental data.

19. The non-transitory computer-readable storage medium of claim 15, wherein the processing device is further to:
generate a user interface for presenting the indication of the one or more items of content that are to be provided to the one or more of the plurality of entities; and
provide the user interface comprising the indication to the third-party system.

20. The non-transitory computer-readable storage medium of claim 15, wherein the corresponding ex post data comprises corresponding performance statistics for each of the plurality of entities.
